(19) United States
(12) Patent Application Publication
(10) Pub. No.: US 2025/0036289 A1
(43) Pub. Date: Jan. 30, 2025

(54) PROGRESSIVE REDUNDANT ARRAY OF INEXPENSIVE DISKS (RAID) FOR MEMORY DEVICES

(71) Applicant: SK Hynix NAND Product Solutions Corp. (dba Solidigm), Rancho Cordova, CA (US)

(72) Inventors: Chaohong HU, San Jose, CA (US); Gulzar KATHAWALA, Fremont, CA (US); Yogesh WAKCHAURE, Folsom, CA (US)

(21) Appl. No.: 18/227,256

(22) Filed: Jul. 27, 2023

(51) Int. Cl. G06F 3/06

(52) U.S. Cl. CPC G06F 3/0619; G06F 3/065; G06F 3/0688; G06F 12/0292; G06F 2212/1032

(57) ABSTRACT

This application is directed to storing data by distributing redundant data blocks across multiple memory devices (e.g., solid-state drives (SSDs)) and based on multiple RAID schemes. An electronic system mirrors user data on two distinct memory devices. Integrity data is generated based on the user data and stored on an integrity memory device. In accordance with a determination that the integrity data of the user data is stored on the integrity memory device, the electronic system releases the user data mirrored on at least one of the two distinct memory devices. In some embodiments, a copy of the user data is also stored on one of a plurality of data memory devices. The integrity data is generated based on the user data and stored on the integrity memory device, in accordance with a determination that the plurality of data memory devices is filled.

### TECHNICAL FIELD

This application relates generally to memory management including, but not limited to, methods, systems, and non-transitory computer-readable media for storing data by distributing redundant data blocks across multiple memory devices (e.g., multiple memory dies in a solid-state drives (SSD)).

### BACKGROUND

Memory is applied in a computer system to store instructions and data. The data are processed by one or more processors of the computer system according to the instructions stored in the memory. Multiple memory units are used in different portions of the computer system to serve different functions. Specifically, the computer system includes non-volatile memory that acts as secondary memory to keep data stored thereon if the computer system is decoupled from a power source. Examples of the secondary memory include, but are not limited to, hard disk drives (HDDs) and solid-state drives (SSDs). Secondary memory of the computer system oftentimes applies a redundant array of inexpensive disks (RAID), which is a virtualization technology of data storage that combines multiple physical storage drives into single or multiple logical units for data redundancy and optimization performance. RAIDS can be configured into different levels in SSDs, enabling improved performance levels and data security. The Storage Networking Industry Association (SNIA) standardized RAID levels and their associated data formats. Data center SSDs usually apply block-level striping with dedicated parity bits (RAID 4) or distributed parity bits (RAID 5) to meet an uncorrectable bit-error rate (UBER) requirement. However, RAID 4 or RAID 5 cannot be applied efficiently in some replacement modes that require many open isolation units with frequent asynchronous update within an XOR strip. It would be beneficial to apply a practical data storage and validation mechanism to store data involving many open isolation units.

### SUMMARY

Various embodiments of this application are directed to methods, systems, devices, non-transitory computer-readable media for storing data by distributing redundant data blocks across multiple memory devices (e.g., NAND dies) and based on multiple RAID schemes (e.g., RAID 1 and RAID 4). A first level RAID includes RAID 1, and is applied to buffer data in response to a host write. The data is mirrored on two distinct memory devices (e.g., two NAND dies). A copy of the data is written in a first isolation unit (e.g., a memory block of another memory device). When a memory system completely fills one or more isolation units including the first isolation unit, the memory system generates integrity data for data stored in the first isolation unit via a batch fashion and stored the integrity data according to a second level RAID (e.g., RAID 4 or RAID 5). After the integrity data is stored, at least one copy of the data stored according to the first level RAID is invalidated or released. RAID 1 is applied to store data in an asynchronous write having a fine data granularity level, and RAID 4 and RAID 5 are applied to store data, in batch, protected by integrity data. In an example placement mode. RAID 1 offers better performance on the fine data granularity level while using more temporary storage space. Conversely. RAID 4 and RAID 5 conserve storage space that is wasted in RAID 1 for data duplication, and cannot offer the same data granularity level as RAID 1. In various embodiments of this application, two levels of RAID schemes are applied jointly to benefit from both the fine data granularity level of RAID 1 and the high storage space utilization rate of RAID 4 or RAID 5, thereby meeting a UBER requirement of a memory system at a reasonable hardware cost.

In one aspect, a method is implemented at an electronic system to store data on a memory system (e.g., including a plurality of memory channels). The method includes mirroring user data on two distinct memory devices, generating integrity data based on the user data, and storing the integrity data of the user data on an integrity memory device. The method further includes in accordance with a determination that the integrity data of the user data is stored on the integrity memory device, releasing the user data mirrored on at least one of the two distinct memory devices. In some embodiments, the two distinct memory devices and the integrity memory device correspond to different NAND dies of an SSD.

In some embodiments, a memory zone includes a memory block of the integrity memory device and a plurality of memory blocks of a plurality of data memory devices including a first data memory device. The method further includes storing a copy of the user data on the first data memory device, and the integrity data is generated based on a subset of user data of each of a subset of data memory devices including the first data memory device. Further, in some embodiments, the method further includes determining whether one or more memory blocks of the plurality of data memory devices of the memory zone is filled. The integrity data of the user data is generated based on the user data and stored on the integrity memory device, in accordance with a determination that one or more memory blocks of the plurality of data memory devices is filled. Additionally, in some embodiments, the methods includes erasing the copy of the user data from the first data memory device by updating the integrity data to exclude the copy of the user data stored on the first data memory device from the subset of user data applied to generate the integrity data and modifying a logical-to-physical (L2P) table to disassociate a physical address of the first data memory device where the copy of the user data is stored with a corresponding logical address associated with the user data.

Some implementations of this application include an electronic device that includes one or more processors and memory having instructions stored thereon, which when executed by the one or more processors cause the processors to perform any of the above methods on a memory system (e.g., one or more SSDs).

Some implementations include a non-transitory computer readable storage medium storing one or more programs. The one or more programs include instructions, which when executed by one or more processors cause the processors to implement any of the above methods on a memory system (e.g., one or more SSDs).

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of an example system module in a typical electronic device in accordance with some embodiments.

FIG. 2 is a block diagram of a memory system of an example electronic device having one or more memory access queues, in accordance with some embodiments.

FIG. 3 illustrates an example progressive RAID scheme integrating two RAID schemes (e.g., RAID 1 and RAID 4), in accordance with some embodiments.

FIG. 4 illustrates another example progressive RAID scheme integrating two RAID schemes, in accordance with some embodiments.

FIG. 5 is a flow diagram of an example method for storing data in a memory system, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

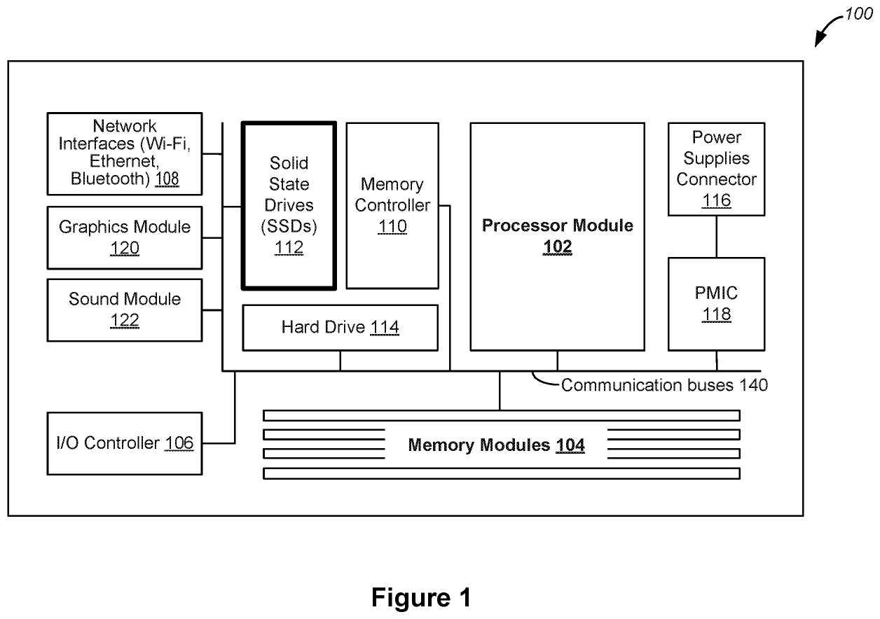

FIG. 1 is a block diagram of an example system module 100 in a typical electronic device in accordance with some embodiments. The system module 100 in this electronic device includes at least a processor module 102, memory modules 104 for storing programs, instructions and data, an input/output (I/O) controller 106, one or more communication interfaces such as network interfaces 108, and one or more communication buses 140 for interconnecting these components. In some embodiments, the I/O controller 106 allows the processor module 102 to communicate with an I/O device (e.g., a key board, a mouse or a trackpad) via a universal serial bus interface. In some embodiments, the network interfaces 108 includes one or more interfaces for Wi-Fi, Ethernet and Bluetooth networks, each allowing the electronic device to exchange data with an external source, e.g., a server or another electronic device. In some embodiments, the communication buses 140 include circuitry (sometimes called a chipset) that interconnects and controls communications among various system components included in system module 100.

In some embodiments, the memory modules 104 include high-speed random-access memory, such as DRAM, static random-access memory (SRAM), double data rate (DDR) dynamic random-access memory (RAM), or other random-access solid state memory devices. In some embodiments, the memory modules 104 include non-volatile memory, such as one or more magnetic disk storage devices, optical disk storage devices, flash memory devices, or other non-volatile solid state storage devices. In some embodiments, the memory modules 104, or alternatively the non-volatile memory device(s) within the memory modules 104, include a non-transitory computer readable storage medium. In some embodiments, memory slots are reserved on the system module 100 for receiving the memory modules 104. Once inserted into the memory slots, the memory modules 104 are integrated into the system module 100.

In some embodiments, the system module 100 further includes one or more components selected from a memory controller 110, one or more solid state drives (SSDs) 112, a hard disk drive (HDD) 114, power management integrated circuit (PMIC) 118, a graphics module 120, and a sound module 122. The memory controller 110 is configured to control communication between the processor module 102 and memory components, including the memory modules 104, in the electronic device. The SSDs 112 are configured to apply integrated circuit assemblies to store data in the electronic device, and in many embodiments, are based on NAND or NOR memory configurations. The HDD 114 is a conventional data storage device used for storing and retrieving digital information based on electromechanical magnetic disks. The power supply connector 116 is electrically coupled to receive an external power supply. The PMIC 118 is configured to modulate the received external power supply to other desired DC voltage levels, e.g., 5V, 3.3V or 1.8V, as required by various components or circuits (e.g., the processor module 102) within the electronic device. The graphics module 120 is configured to generate a feed of output images to one or more display devices according to their desirable image/video formats. The sound module 122 is configured to facilitate the input and output of audio signals to and from the electronic device under control of computer programs.

It is noted that communication buses 140 also interconnect and control communications among various system components including components 110-122.

Further, one skilled in the art knows that other non-transitory computer readable storage media can be used, as new data storage technologies are developed for storing information in the non-transitory computer readable storage media in the memory modules 104 and in SSDs 112. These new non-transitory computer readable storage media include, but are not limited to, those manufactured from biological materials, nanowires, carbon nanotubes and individual molecules, even though the respective data storage technologies are currently under development and yet to be commercialized.

Some implementations of this application is directed to storing data by applying multiple RAID schemes (e.g., RAID 1 and RAID 4) including distributing redundant data blocks across multiple memory devices (e.g., one or more SSDs each including a plurality of NAND dies) temporarily. Two levels of RAID schemes are applied jointly to benefit from both a fine data granularity level of RAID 1 and a high storage space utilization rate of RAID 4 or RAID 5. Such integration of multiple RAID schemes can meet a UBER requirement of a memory system at a reasonable hardware cost. Specifically, a first level RAID includes RAID 1, and is applied to buffer data in response to a host write. The data is mirrored on two distinct memory devices (e.g., two NAND dies). Based on a second level RAID (e.g., RAID 4 or RAID 5), a copy of the data is written in a first isolation unit (e.g. a memory block of a data memory device). When a memory system completely fills one or more isolation units including the first isolation unit, the memory system generates integrity data for data stored in the first isolation unit via a batch fashion and stored the integrity data according to the second level RAID. After the integrity data is stored, at least one copy of the data stored according to the first level RAID is invalidated or released.

RAID is a virtualization technology of data storage that combines multiple physical storage drives into single or multiple logical units for data redundancy and optimization performance. The Storage Networking Industry Association (SNIA) standardized RAID levels (e.g., RAID 0), . . . , and RAID 6) and associated data formats. For example, RAID 0) is implemented based on striping, and does not have data mirroring or parity. In RAID 1, data is mirrored on two distinct memory devices (e.g., NAND dies). RAID 4 is implemented based on block-level striping with a dedicated parity disk. RAID 5 is implemented based on block-level striping with distributed parity.

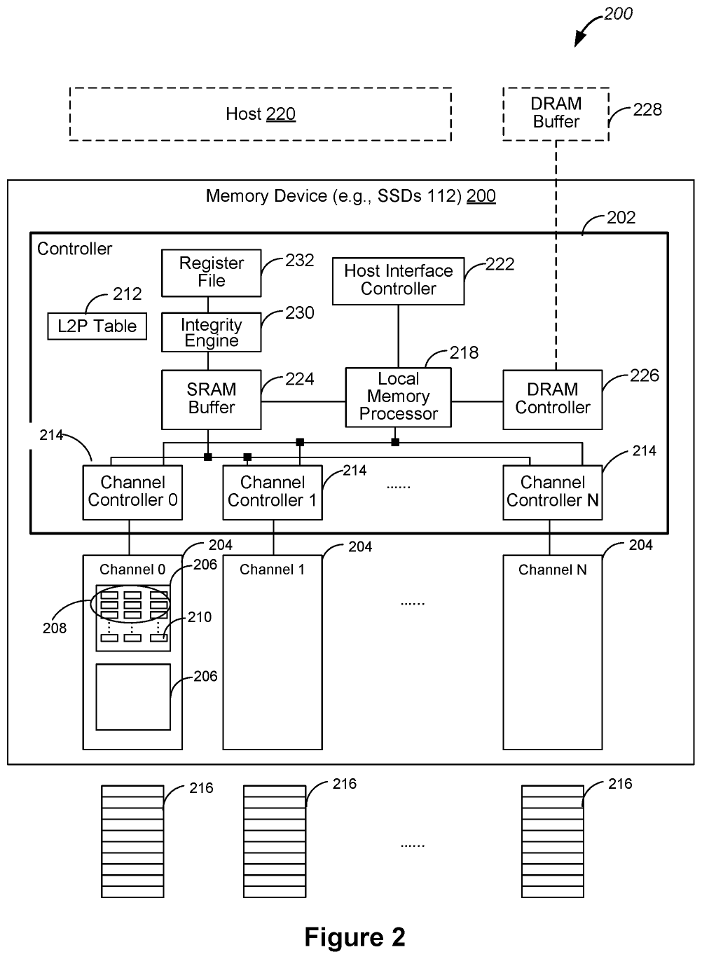

FIG. 2 is a block diagram of a memory system 200 of an example electronic device having one or more memory access queues, in accordance with some embodiments. The memory system 200 is coupled to a host device 220 (e.g., a processor module 102 in FIG. 1) and configured to store instructions and data for an extended time, e.g., when the electronic device sleeps, hibernates, or is shut down. The host device 220 is configured to access the instructions and data stored in the memory system 200 and process the instructions and data to run an operating system and execute user applications. The memory system 200 further includes a controller 202 and a plurality of memory channels 204. Each memory channels 204 includes a plurality of memory cells. The controller 202 is configured to execute firmware level software to bridge the plurality of memory channels 204 to the host device 220.

Each memory channel 204 includes on one or more memory packages 206 (e.g., two memory chips, two memory dies). In an example, each memory package 206 corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the memory system 200 includes a single-level cell (SLC) die, and each memory cell stores a single data bit. In some embodiments, the memory system 200 includes a multi-level cell (MLC) die, and each memory cell stores 2 data bits. In an example, each memory cell of a triple-level cell (TLC) die stores 3 data bits. In another example, each memory cell of a quad-level cell (QLC) die stores 4 data bits. In yet another example, each memory cell of a penta-level cell (PLC) die stores 5 data bits. In some embodiments, each memory cell can store any suitable number of data bits. Compared with the non-SLC die (e.g., MLC die, TLC die, QLC die, PLC die), the SLC die operates with a higher speed, a higher reliability, and a longer lifespan, and however, has a lower device density and a higher price.

Each memory channel 204 is coupled to a respective channel controller 214 configured to control internal and external requests to access memory cells in the respective memory channel 204. In some embodiments, each memory package 206 (e.g., each memory die) corresponds to a respective queue 216 of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the memory system 200 corresponds to a single queue 216 of memory access requests. Each memory access request is optionally received internally from the memory system 200 to manage the respective memory channel 204 or externally from the host device 220 to write or read data stored in the respective channel 204. Specifically, each memory access request includes one of: a system write request that is received from the memory system 200 to write to the respective memory channel 204, a system read request that is received from the memory system 200 to read from the respective memory channel 204, a host write request that originates from the host device 220 to write to the respective memory channel 204, and a host read request that is received from the host device 220 to read from the respective memory channel 204. It is noted that system read requests (also called background read requests or non-host read requests) and system write requests are dispatched by a memory controller to implement internal memory management functions including, but are not limited to, garbage collection, wear levelling, read disturb mitigation, memory snapshot capturing, memory mirroring, caching, and memory sparing.

In some embodiments, in addition to the channel controllers 214, the controller 202 further includes a local memory processor 218, a host interface controller 222, an SRAM buffer 224, and a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks are written into, or read from, the plurality of channels jointly. No data in the same memory block is written via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the controller 202. Alternatively, in some embodiments, the local memory processor 218 stores data to be written into, or read from, each memory block in the plurality of memory channels 204 in a DRAM buffer 228 that is main memory used by the processor module 102 (FIG. 1). The local memory processor 218 of the controller 202 accesses the DRAM buffer 228 via the host interface controller 222.

In some embodiments, the memory system 200 includes one or more SSDs, and each SSD has a logical-to-physical (L2P) address mapping table 212 (also called L2P table 212) that stores physical addresses for a set of logical addresses, e.g., a logic block address (LBA). In an example, the SSD has a memory capacity of 32 terabytes (i.e., 32 TB) organized into a plurality of memory sectors, and each memory sector stores 4096 bytes (i.e., 4 KB) and is individually addressable. The SSD includes 8 billion memory sectors identified by 8 billion physical addresses. At least 33 data bits are needed to uniquely represent each and every individual physical address of the SSDs having 8 billion physical addresses. Further, in some embodiments, the SSD includes NAND memory cells, and reserves extra memory space by overprovisioning. For example, overprovisioning is 25%, and the SSD has 10 billion memory sectors to be identified by 10 billion unique physical addresses. At least 34 data bits are needed to uniquely identify each and every individual physical address of the SSD having 10 billion physical addresses.

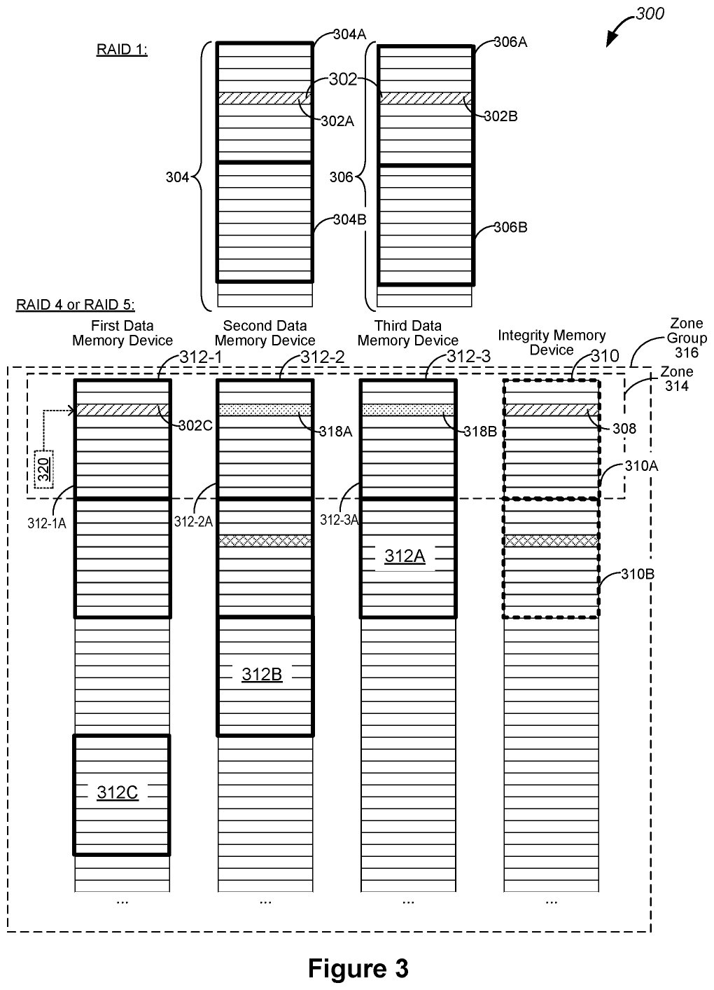

In some embodiments, data in the memory system 200 is grouped into coding blocks, and each coding block is called a codeword (e.g. a combination of user data 302C, 318A, and 318B in FIG. 3). For example, each codeword includes n bits among which k bits correspond to user data and m corresponds to integrity data of the user data, where k, m, and n are integers and n is a sum of k and m. In some embodiments, the memory system 200 includes an integrity engine 230 (e.g., an LDPC engine) and a register file 232 including an arrange of registers and coupled to the integrity engine 230. The integrity engine 230 is coupled to the memory channels 204 via the channel controllers 214 and SRAM buffer 224. Specifically, in some embodiments, the integrity engine 230) has data path connections to the SRAM buffer 224, which is further connected to the channel controllers 214 via data paths that are controlled by the local memory processor 218. The integrity engine 230 is configured to verify data integrity for each coding block of the memory channels 204 using variable nodes and check nodes, and messages are exchanged between the variable and check nodes during the integrity check process. A subset of these messages is selected and temporarily stored in the register file 232 as variable node data or check node data.

FIG. 3 illustrates an example progressive RAID scheme 300 integrating two RAID schemes, in accordance with some embodiments. A host device 220 is coupled to a memory system 200 including a plurality of memory devices. An example of a memory device is an HDD or an SSD. Each memory device includes a plurality of memory channels 204 each of which further includes a plurality of memory planes 208 each further including a plurality of memory pages 210. In some embodiments, each memory channel 204 includes one or more distinct memory dies. In some embodiments, user data 302 are mirrored on two distinct memory devices 304 and 306 to create two copies 302A and 302B of the user data. Integrity data 308 is generated based on the user data 302 and stored on an integrity memory device 310. In accordance with a determination that the integrity data 308 of the user data 302 is stored on the integrity memory device 310, the user data 302 mirrored on at least one of the two distinct memory devices 304 and 306 is released. In some embodiments, the host device 220 sends a host write request to the plurality of memory devices. The user data 302 is mirrored on the two distinct memory devices 304 and 306 in response to the host write request. Further, in some embodiments, another copy 302C of the user data is stored on a first data memory device 312-1 in response to the host write request received from the host device 220).

In some embodiments, after being mirrored in the two distinct memory devices 304 and 306, the user data 302 is copied to a first data memory device 312-1, and the integrity data 308 is generated based on a copy 302C of the user data in the first data memory device 312-1. Specifically, the copy 302C of the user data is stored in a memory block of the first data memory device 312-1, which forms a memory zone 314 with memory blocks of one or more additional data memory devices 312 (e.g., 312-2, 312-3) and the integrity memory device 310. Stated another way, in some embodiments, a memory zone 314 includes a memory block 310A of the integrity memory device 310 and a plurality of memory blocks of a plurality of data memory devices 312 including a first data memory device 312-1. Each memory block includes a plurality of memory pages 210 (FIG. 2) of a respective memory device 310 or 312. A copy 302C of the user data is stored on the first data memory device 312-1. The integrity data 308 is generated based on a subset of user data of each of a subset of data memory devices 312 including the first data memory device 312-1. In an example, the integrity data 308 is generated based on the copy 302C of the user data 318A and 318B stored in the data memory devices 312-2 and 312-3. In some embodiments, the integrity data 308 is generated when at least one of the memory blocks of the data memory devices 312 of the memory zone 314 is filled or closed for further writing. In other words, in many situations, the integrity data 308 is not generated as soon as the copy 302C of the user data is stored in the first data memory device 312-1.

In some embodiments, after the integrity data 308 is stored in the integrity memory device 310, both copies 302A and 302B in the two distinct memory devices 304 and 306 are invalidated and released. Alternatively, in some embodiments, the first data memory device 312-1 includes one of the two distinct memory devices 304 and 306. The user data 302 is duplicated in the two distinct memory devices 304 and 306 without being stored in an additional separate and distinct first data memory device any more. After the integrity data 308 is stored in the integrity memory device 310, one copy 302A or 302B of the user data stored in the memory device 304 or 306 is invalidated and released, while the other copy 302B or 302A of the user data stored in the memory device 306 or 304 is used as the copy 302C of the user data in the first data memory device 312-1.

In some embodiments, when the copy 302C of user data is erased from the first data memory device 312-1, the corresponding integrity data 308 is updated to exclude the copy 302C of the user data stored on the first data memory device 312-1 from the subset of user data applied to generate the integrity data 308. For example, the integrity data 308 includes a parity check result generated using an XOR logic based on the copy 302C of user data stored in the memory device 312-1 and the user data 318A and 318B stored in the memory devices 312-2 and 312-3. In response to a request to erase, invalidate, or release the copy 302 of user data in the memory device 312-2, the memory system 200 updates the integrity data 308 by updating the parity check result using the XOR logic based on the user data 318A and 318B stored in the memory devices 312-2 and 312-3. An L2P table 212 is modified by the memory controller 202 to disassociate a physical address of the first data memory device 312-1 where the copy 302C of the user data is stored with a corresponding logical address associated with the user data 302. In some embodiments, the copy 302C of user data is physically purged from the first data memory device 312-1. Alternatively, the copy 302C of user data remains in the first data memory device 312-1, until it is overwritten by next data 320. The copy 302C of user data cannot be accessed because the L2P table does not link its physical address to any logical address any more. Further, in some situations, the next data 320 is written in the first data memory device 312-1 in place of the copy 302C of the user data. The L2P table is modified to associate the physical address of the first data memory device 312-1 with a next logical address associated with the next data 320. The integrity data 308 is updated based on the next data 320.

In some embodiments, the two distinct memory devices 304 and 306 have the same memory type. For example, each of the two distinct memory devices 304 and 306 includes a QLC memory die and has a plurality of memory blocks (e.g., 304A, 304B, 306A, 306B), and each memory block includes a plurality of memory pages 210 each of which includes a plurality of QLC memory cells. Alternatively, in some embodiments, each of the two distinct memory devices 304 and 306 includes an SLC memory die and has a plurality of memory blocks (e.g., 304A, 304B, 306A, 306B), and each memory block includes a plurality of memory pages 210) each of which includes a plurality of SLC memory cells. Alternatively, in some embodiments, each of the two distinct memory devices 304 and 306 includes an MLC memory die and has a plurality of memory blocks (e.g., 304A, 304B, 306A, 306B), and each memory block includes a plurality of memory pages 210 each of which includes a plurality of MLC memory cells. Alternatively, in some embodiments, each of the two distinct memory devices 304 and 306 includes a storage class memory (SCM) selected from a group consisting of: phase-change memory (PCM), resistive random-access memory (ReRAM), magnetoresistive random-access memory (MRAM), and 3D XPoint memory. SCM is a type of physical computer memory that combines DRAM, NAND flash memory, and a power source for data persistence. In some embodiments, SCM treats non-volatile memory as DRAM and includes it in a server's memory space.

Alternatively, in some embodiments, the two distinct memory devices 304 and 306 have different memory types. For example, the memory device 304 includes a QLC-based memory die and used as the first data memory device 312-1 storing the copy of the user data 302C. The memory device 306 is optionally based on SLC, MLC, or SCM. The user data 302B duplicated on the memory device 306 is released or erased In accordance with a determination that the integrity data 308 (e.g., parity data) of the user data 302 is stored on the integrity memory device 310.

In some embodiments, the integrity memory device 310 includes one of an MLC memory die and an SLC memory die and has a plurality of memory blocks (e.g., 310A and 310B), and each memory block includes a plurality of memory pages each of which includes a plurality of MLC or SLC memory cells. In an example, RAID 5 is applied to generate the integrity data 308, and the integrity memory device 310 storing the integrity data 308 includes SLC memory cells, thereby benefiting from endurance of the SLC memory cells. In some situations, given a relatively low endurance level of TLC or QLC, the integrity memory device 310 does not include TCL and QLC memory cells or any higher level memory cells. Alternatively, in some embodiments, the integrity memory device 310 includes an SCM selected from a group consisting of: PCM, ReRAM, MRAM, and 3D XPoint memory. In some embodiments, the data memory devices 312 and integrity memory device 310 have the same memory type.

In some embodiments, each of the two distinct memory devices 304 and 306 and the integrity memory device 310 includes at least one distinct memory die of the memory system 200. In some embodiments, each of the two distinct memory devices 304 and 306 and the integrity memory device 310 includes a distinct memory die of a memory system.

In some embodiments (FIG. 3), the integrity data 308 is stored in accordance with a RAID 4 scheme in which integrity data generated for memory blocks of data memory devices 312 is saved in a consolidated manner, e.g., in the dedicated integrity memory device 310. Alternatively, in some embodiments, the integrity data 308 is stored in accordance with a RAID 5 scheme in which integrity data generated for memory blocks of data memory devices 312 is saved in a distributed manner. Memory blocks of integrity data are distributed uniformly among the memory devices 310 and 312. For example, integrity data is stored in each of the memory blocks 310A, 312A, 312B, and 312C based on user data stored in three corresponding memory blocks of user data.

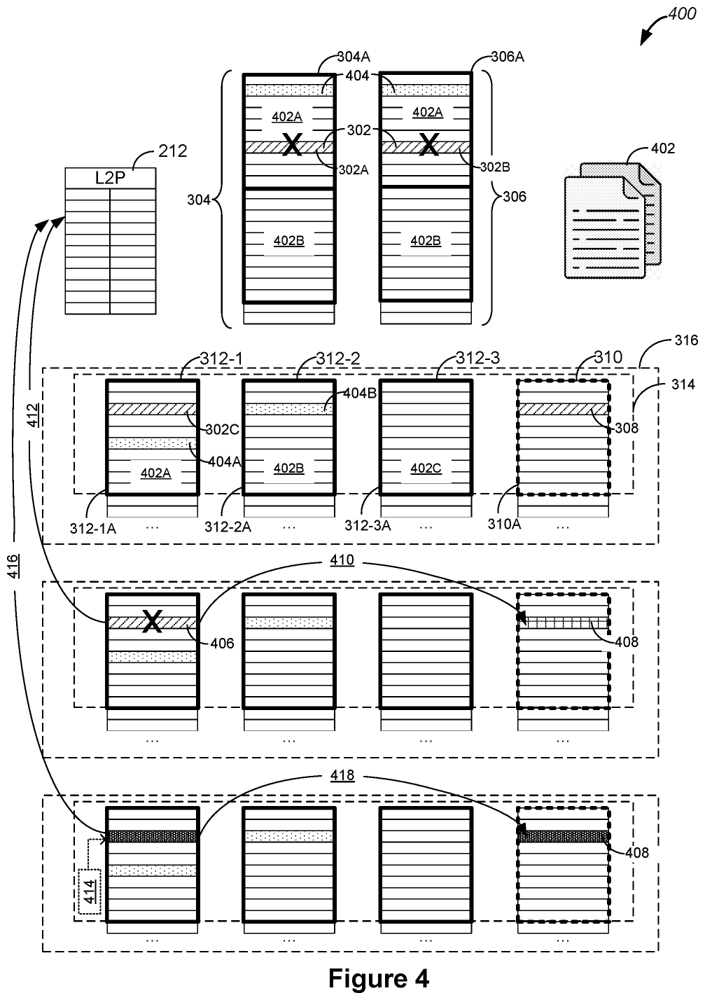

FIG. 4 illustrates another example progressive RAID scheme 400 integrating two RAID schemes, in accordance with some embodiments. In an example, user data 302 is stored based on RAID 1 and RAID 4 schemes. In another example, the user data 302 is stored based on RAID 1 and RAID 5 schemes. In some embodiments, the user data 302 is stored based on a first RAID scheme and a second RAID scheme, where the first RAID scheme is temporarily applied and has a finer data granularity level than the second RAID scheme. User data 302 are mirrored on two distinct memory devices 304 and 306 to create two copies 302A and 302B of the user data 302. Integrity data 308 is generated based on the user data 302 and stored on an integrity memory device 310. In accordance with a determination that the integrity data 308 of the user data 302 is stored on the integrity memory device 310, the user data 302 mirrored on at least one of the two distinct memory devices 304 and 306 is released. In some embodiments, a copy 302C of the user data 302 is stored on a first data memory device 312-1, and in accordance with a determination that the integrity data 308 of the user data 302 is stored on the integrity memory device 310, the user data 302 mirrored on both of the two distinct memory devices 304 and 306 is released. Further, in some embodiments, the memory device 304 or 306 is released by dissociating a physical address of the memory device 304 or 306 with a corresponding logical address, while the memory device 304 or 306 may or may not be physically purged.

Stated another way, the copies 302A and 302B of the user data are temporarily stored in a duplicated manner, until the integrity data 308 is generated and stored for a copy 302C of the same user data. Generation of the integrity data 308 is delayed from duplication of the copies 302A and 302B of the user data, because it has to wait until a memory block 302 including user data corresponding to the integrity data 308 is filled or closed. In some embodiments, a memory zone 314 includes a memory block 312A-1, 312-2A, 312-3A or 310A of each of one or more data memory device 312 (e.g., 312-1, 312-2, and 312-3) and the integrity memory device 310, and each memory block includes a plurality of memory pages 210. In some situations, the integrity data 308 is not generated as soon as the copy 302C of the user data is stored in the first data memory device 312-1. Instead, the integrity data 308 is generated when at least one of the memory blocks 312-1A, 312-2A, or 312-3A of the data memory devices 312 of the memory zone 314 is filled or closed from further writing. For example, the memory controller 202 determines that the memory block 312-1A including the copy 302C of the user data 302 is filled or closed from further writing, and a memory block 310A of integrity data is generated and stored based on the memory block 312-1A of user data. Further, in some embodiments, the memory block 312-2A is neither filled/closed nor used to generate the memory block 310A of integrity data. Alternatively and additionally, in some embodiments, the memory blocks 312-2A and 312-3A are also filled and used to generate the memory block 310A of integrity data jointly with the memory block 312-1A.

Stated another way, in some embodiments, a plurality of data blocks 402A-402C of a data file 402 is stored on a plurality of data memory devices (e.g., 304, 306, 312-1, 312-2, 312-3, and 310). The plurality of data blocks 402A-402C includes a first data block 402A further including user data 302. The first data block 402A is mirrored on the two distinct memory devices 304 and 306, while the first data block 402A is stored on a first data memory device 312-1 of the plurality of data memory devices 312. Further, in some embodiments, the plurality of data blocks 402A-402C of the data file 402 is stored in accordance with a predefined redundant array of inexpensive disks (RAID) level. The predefined RAID level is selected from RAID 4 and RAID 5, and the first data block of the data file is stored on the first data memory device 312-1. The user data 302 is mirrored on the two distinct memory devices 304 and 306 in accordance with RAID 1.

In some embodiments, the user data 302 includes first user data. The data file 402 further includes second user data 404. The second user data 404 is mirrored on two corresponding memory devices distinct from the plurality of data memory devices 312 in accordance with RAID 1. In some embodiments, the second user data 404 is mirrored on the two distinct memory devices 304 and 306, before the integrity data 308 is generated based on the first user data 302 and stored in the integrity memory device 310. In some embodiments, both user data 302 and 404 are stored in the memory block 312-1A of the first data memory device 312-1, and the memory block 310A of integrity data is generated when the memory block 312-1A is filled or closed.

Alternatively, in some embodiments, the second user data 404 is mirrored on the two distinct memory devices 304 and 306, after the integrity data 308 is generated based on the first user data 302 and stored in the integrity memory device 310. The user data 302 and 404B are stored separately in the memory blocks 312-1A and 312-2A of two distinct data memory devices 312-1 and 312-2. The memory block 310A of integrity data is generated when the memory block 312-1A is filled or closed, independently of whether the memory blocks 312-2A and 312-3A are filled or closed. After the memory block 312-1A is filled or closed, the memory block 310A of integrity data is updated based on the memory block 312-1A. Specifically, in some situations, when the memory block 312-1A is filled or closed, the memory blocks 312-2A and 312-3A are not filled or closed, and the memory block 310A of integrity data is generated based on the memory block 312-1A. When the second user data 404B is written into the memory block 312-2A and the memory block 312-2A is subsequently filled or closed, the memory block 312-3A is not filled or closed, and the memory block 310A of integrity data is generated or updated based on data stored in the memory blocks 312-1A and 312-2A.

Additionally and alternatively, in some situations, when the memory block 312-1A is filled or closed after a copy 302C of the user data 302 is written, the memory blocks 312-2A and 312-3A are already filled or closed, and the memory block 310A of integrity data is generated based on data stored in the memory blocks 312-1A, 312-2A, and 312-3A. When the memory block 312-2A is invalidated or released, the memory block 310A of integrity data is generated or updated based on data stored in the memory blocks 312-1A and 312-3A, independently of whether corresponding user data is physically purged from the memory block 312-2A. When the second user data 404B is written into the memory block 312-2A and the memory block 312-2A is subsequently filled or closed, the memory block 310A of integrity data is generated or updated based on data stored in the memory blocks 312-1A, 312-2A, and 312-3A.

In some embodiments, user data 406 is stored in the memory block 312-1A of the first data memory device 312-1, and corresponds to integrity data 408 stored in the memory block 310A of the integrity memory device 310. When the user data 406 is erased from the first data memory device 312-1, the integrity data 408 is updated (operation 410) to exclude the user data 406 stored on the first data memory device 312-1 from a subset of user data applied to generate the integrity data 408. An L2P table 212 is updated (operation 412) to disassociate a physical address of the first data memory device 312-1 where the user data 406 is stored with a corresponding logical address associated with the user data 406. Further, in some embodiments, next data 414 is written in the first data memory device 312-1 in place of the user data 406, and the L2P table 212 is updated (operation 416) to associate the physical address of the first data memory device 312-1 with a next logical address associated with the next data 414. The integrity data 408 is also updated (operation 418) based on the next data 414. In some embodiments, the user data 406 includes a copy 302C of user data 302, and is replaced with the next data 320 (FIG. 3). The integrity data 308 corresponding to the copy 302C of user data 302 is updated accordingly.

In some embodiments, data is stored as redundant data blocks are distributed across multiple memory devices (e.g., NAND dies) and based on multiple RAID schemes (e.g., RAID 1 and RAID 4). A first level RAID includes RAID 1, and is applied to buffer data in response to a host write. The data is mirrored on two distinct memory devices (e.g., NAND dies). A copy of the data is written in a first isolation unit 312-1A. When a memory system completely fills one or more isolation units (e.g., 312-1A, 312-2A, and/or 312-3A) forming a memory zone 314 including the first isolation unit, the memory system generates a memory block 310A of integrity data for data stored in the first isolation unit via a batch fashion and stored the integrity data according to a second level RAID (e.g., RAID 4 or RAID 5). RAID 1 is applied to store data in an asynchronous write having a fine data granularity level, and RAID 4 or RAID 5 is applied to store data protected by integrity data while the integrity data is generated on a memory block level. After the integrity data is stored, at least one copy of the data stored according to the first level RAID is invalidated or released. Only one copy of user is stored with corresponding integrity data. Memory space used to store the second copy of user data is saved, while data integrity is still available. As such, RAID 1 is applied on a fine data granularity level, and RAID 4 or RAID 5 is applied on a large data block level, thereby conserving space of the memory system 200 without comprising data integrity.

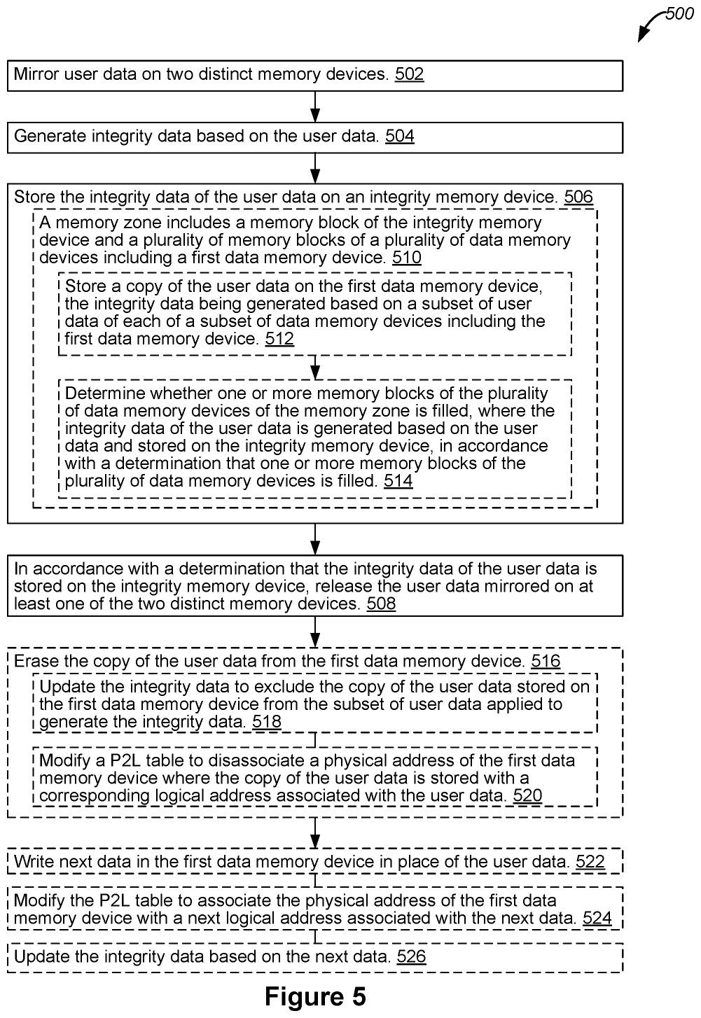

FIG. 5 is a flow diagram of an example method 500 for storing data in a memory system, in accordance with some embodiments. The method 500 is implemented at an electronic system including a memory system 200 (FIG. 2), and the memory system 200 optionally includes a plurality of memory devices (e.g., NAND dies). The electronic system mirrors (operation 502) user data 302 on two distinct memory devices 304 and 306 (FIG. 3) and generates (operation 504) integrity data 308 based on the user data 302. The integrity data 308 of the user data 302 is stored (operation 506) on an integrity memory device 310. In accordance with a determination that the integrity data 308 of the user data 302 is stored on the integrity memory device 310, the electronic system releases (operation 508) the user data 302 mirrored on at least one of the two distinct memory devices 304 and 306.

In some embodiments, a memory zone 314 (FIG. 3) includes (operation 510) a memory block (e.g., 310A) of the integrity memory device 310 and a plurality of memory blocks (e.g., 312-1A, 312-2A, and 312-3A) of a plurality of data memory devices 312 including a first data memory device 312-1. The electronic system stores (operation 512) a copy 302C of the user data 302 on the first data memory device 312-1. The integrity data 308 is generated based on a subset of user data of each of a subset of data memory devices 312 including the first data memory device 312-1. Further, in some embodiments, the electronic system determines (operation 514) whether one or more memory blocks of the plurality of data memory devices 312 of the memory zone 314 is filled. The integrity data 308 of the user data 302 is generated based on the user data 302 and stored on the integrity memory device 310, in accordance with a determination that one or more memory blocks of the plurality of data memory devices 312 (e.g., memory block 312-1A, 312-B, or 312-C) is filled. Further, in some embodiments, the memory system receives a host write request. The user data 302 is mirrored on the two distinct memory devices 304 and 306 and the copy 302C of the user data 302 is stored on the first data memory device 312-1 in response to the host write request.

In some embodiments, the electronic system further erases (operation 516) the copy 302C of the user data 302 from the first data memory device 312-1 by updating (operation 518) the integrity data 308 to exclude the copy 302C of the user data 302 stored on the first data memory device 312-1 from the subset of user data 302 applied to generate the integrity data 308 and modifying (operation 520) a logical-to-physical (L2P) table 212 (FIG. 2) to disassociate a physical address of the first data memory device 312-1 where the copy 302C of the user data 302 is stored with a corresponding logical address associated with the user data 302. Further, in some embodiments, the electronic system writes (operation 522) next data 320 (FIG. 3) in the first data memory device 312-1 in place of the user data 302, modifies (operation 524) the L2P table 212 to associate the physical address of the first data memory device 312-1 with a next logical address associated with the next data 320, and updates (operation 526) the integrity data 308 based on the next data 320. Alternatively, in some embodiments, the copy 302C of the user data 302 is erased from the first data memory device 312-1 by purging the copy 302C of the user data 302 from the first data memory device 312-1.

In some embodiments, each of the two distinct memory devices 304 and 306 includes a quad-level-cell (QLC) memory die and has a plurality of memory blocks, and each memory block includes a plurality of memory pages 210 each of which includes a plurality of quad-level memory cells. Alternatively, in some embodiments, each of the two distinct memory devices 304 and 306 includes one of: a single-level-cell (SLC) memory die and a multiple-level-cell (MLC) memory die. In some embodiments, the integrity memory device 310 includes one of an MLC memory die and an SLC memory die and has a plurality of memory blocks (e.g., 310A and 310B in FIG. 3), and each memory block includes a plurality of memory pages each of which includes a plurality of MLCs or SLCs. Alternatively, in some embodiments, at least one of the two distinct memory devices 304 and 306 and integrity memory device 310 includes a storage class memory (SCM) selected from a group consisting of: phase-change memory (PCM), resistive random-access memory (ReRAM), magnetoresistive random-access memory (MRAM), and 3D XPoint memory.

In some embodiments, the electronic system stores a plurality of data blocks (e.g., 402A-402C in FIG. 4) of a data file 402 on a plurality of data memory devices 312. The plurality of data blocks includes a first data block 402A further including user data 302, and the user data 302 is mirrored on the two distinct memory devices 304 and 306 while the first data block 402A is stored on a first data memory device 312-1 of the plurality of data memory devices 312. Further, in some embodiments, the plurality of data blocks of the data file 402 is stored in accordance with a predefined redundant array of inexpensive disks (RAID) level. The predefined RAID level is selected from RAID 4 and RAID 5. The user data 302 is mirrored on the two distinct memory devices 304 and 306 in accordance with RAID 1. In some embodiments, the user data 302 includes first user data, and the data file further includes second user data 404 (FIG. 4). While the second user data 404 is stored on a second data memory device 312-2, the second user data 404 are mirrored on two corresponding memory devices distinct from the plurality of data memory devices 312 in accordance with RAID 1.

In some embodiments, the user data 302 includes first user data. The electronic system mirrors second user data 404 on the two distinct memory devices 304 and 306, before generating the integrity data 308 based on the first user data 302 and storing the integrity data 308 of the first user data 302 on the integrity memory device 310.

In some embodiments, each of the two distinct memory devices 304 and 306 and the integrity memory device 310 includes one or more memory dies. In some embodiments, each of the two distinct memory devices 304 and 306 and the integrity memory device 310 includes a distinct memory die of a memory system. In some embodiments, the integrity data 308 is generated and stored based on a copy 302C of the user data 302, and not generated for the user data 302 mirrored on the two distinct memory devices 304 and 306.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

Various embodiments of this application are directed to methods, systems, devices, and non-transitory computer-readable media for storing data by distributing redundant data blocks across multiple memory devices (e.g., NAND dies) and based on multiple RAID schemes (e.g., RAID 1 and RAID 4). Stated another way, data is stored in a progress RAID scheme in which RAID 1 is applied to store data at a fine data granularity level, until the stored data fills one or more isolation units or an XOR strip and integrity data 308 is thereby generated for the stored data. As a copy of data is stored in QLCs and protected with the integrity data, duplicated data stored in RAID 1 are invalidated or released. More specifically, in an example, for any host write, user are duplicated and written into two QLC memory dies including a target memory zone and a QLC copy block concurrently. These two QLC memory dies include two distinct memory dies. For RAID 4 or RAID 5, no update is available on integrity data if a zone is not full. In some embodiments, the integrity data is updated only when a zone group 316 (FIG. 3) including a plurality of zones is full. In some situations, the integrity data is generated, and the QLC copy block is invalidated and released. Additionally, when a zone group 316 (FIG. 3) is reset (e.g., invalidated or released), the zone group 316 (FIG. 3) is disassociated with a corresponding logic address, and integrity data generated based on the zone group 316 (FIG. 3) is updated without using data in the zone group 316 (FIG. 3).

Integration of multiple RAID schemes can allow memory dies to meet memory endurance requirement (e.g., >1.5K program/erase (P/E) cycles) and a UBER requirement (e.g., <10-¹⁴) of a memory system at a reasonable hardware cost for architectures that rely on NAND placement modes, where the RAID4/RAID5 schemes cannot be directly applied. The SSD system can still achieve the benefits of NAND placement mode architecture like lower write amplification and reduced over provisioning while achieving the desired reliability and performance.

In some embodiments, data are duplicated in SLC-based cache memories 304 and 306 according to a RAID 1 scheme. Integrity data is stored in a QLC-based memory 310 meeting a memory endurance requirement (e.g., >3K P/E cycles). In some embodiments, RAID1 is generalized to small m+1 RAID 4 or RAID 5 if there is m synchronous writes being done by a host system.

The terminology used in the description of the various described implementations herein is for the purpose of describing particular implementations only and is not intended to be limiting. As used in the description of the various described implementations and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises,” and/or “comprising.” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. A method for storing data, comprising:
mirroring user data on two distinct memory devices;
generating integrity data based on the user data;
storing the integrity data of the user data on an integrity memory device; and
in accordance with a determination that the integrity data of the user data is stored on the integrity memory device, releasing the user data mirrored on at least one of the two distinct memory devices.

2. The method of claim 1, wherein a memory zone includes a memory block of the integrity memory device and a plurality of memory blocks of a plurality of data memory devices including a first data memory device, the method further comprising:
storing a copy of the user data on the first data memory device, the integrity data being generated based on a subset of user data of each of a subset of data memory devices including the first data memory device.

3. The method of claim 2, further comprising:
determining whether one or more memory blocks of the plurality of data memory devices of the memory zone is filled, wherein the integrity data of the user data is generated based on the user data and stored on the integrity memory device, in accordance with a determination that one or more memory blocks of the plurality of data memory devices is filled.

4. The method of claim 2, further comprising erasing the copy of the user data from the first data memory device by:
updating the integrity data to exclude the copy of the user data stored on the first data memory device from the subset of user data applied to generate the integrity data; and
modifying a logical-to-physical (L2P) table to disassociate a physical address of the first data memory device where the copy of the user data is stored with a corresponding logical address associated with the user data.

5. The method of claim 4, further comprising:
writing next data in the first data memory device in place of the user data;
modifying the L2P table to associate the physical address of the first data memory device with a next logical address associated with the next data; and
updating the integrity data based on the next data.

6. The method of claim 4, wherein erasing the copy of the user data from the first data memory device by:
purging the copy of the user data from the first data memory device.

7. The method of claim 2, further comprising:
receiving a host write request, wherein the user data is mirrored on the two distinct memory devices and the copy of the user data is stored on the first data memory device in response to the host write request.

8. The method of claim 1, wherein each of the two distinct memory devices includes a quad-level-cell (QLC) solid-state drive (SSD) die and has a plurality of memory blocks, and each memory block includes a plurality of memory pages each of which includes a plurality of quad-level memory cells.

9. The method of claim 1, comprising:
storing a plurality of data blocks of a data file on a plurality of data memory devices, wherein the plurality of data blocks includes a first data block further including user data, and the user data is mirrored on the two distinct memory devices while the first data block is stored on a first data memory device of the plurality of data memory devices.

10. The method of claim 9, wherein:
the plurality of data blocks of the data file is stored in accordance with a predefined redundant array of inexpensive disks (RAID) level, wherein the predefined RAID level is selected from RAID 4 and RAID 5; and
the user data is mirrored on the two distinct memory devices in accordance with RAID 1.

11. The method of claim 9, wherein the user data includes first user data, and the data file further includes second user data, the method further comprising:
while the second user data is stored on a second data memory device, mirroring the second user data on two corresponding memory devices distinct from the plurality of data memory devices in accordance with RAID 1.

12. An electronic device, comprising:
one or more processors; and
memory storing one or more programs configured for execution the one or more processors, the one or more programs comprising instructions for:
mirroring user data on two distinct memory devices;
generating integrity data based on the user data;
storing the integrity data of the user data on an integrity memory device; and
in accordance with a determination that the integrity data of the user data is stored on the integrity memory device, releasing the user data mirrored on at least one of the two distinct memory devices.

13. The electronic device of claim 12, wherein each of the two distinct memory devices and the integrity memory device includes one or more memory dies.

14. The electronic device of claim 12, wherein each of the two distinct memory devices includes one of: a single-level-cell (SLC) memory die, and a multiple-level-cell (MLC) memory die.

15. The electronic device of claim 12, wherein the integrity memory device includes one of an MLC memory die and an SLC memory die and has a plurality of memory blocks, and each memory block includes a plurality of memory pages each of which includes a plurality of MLCs, or SLCs.

16. The electronic device of claim 12, wherein at least one of the two distinct memory devices and integrity memory device includes a storage class memory (SCM) selected from a group consisting of: phase-change memory (PCM), resistive random-access memory (ReRAM), magnetoresistive random-access memory (MRAM), and 3D XPoint memory.

17. A non-transitory computer-readable storage medium storing one or more programs configured for execution one or more processors, the one or more programs comprising instructions for:
mirroring user data on two distinct memory devices;
generating integrity data based on the user data;
storing the integrity data of the user data on an integrity memory device; and
in accordance with a determination that the integrity data of the user data is stored on the integrity memory device, releasing the user data mirrored on at least one of the two distinct memory devices.

19. The non-transitory computer-readable storage medium of claim 17, wherein each of the two distinct memory devices and the integrity memory device includes a distinct memory die of a memory system.

20. The non-transitory computer-readable storage medium of claim 17, wherein the integrity data is generated and stored based on a copy of the user data, and not generated for the user data mirrored on the two distinct memory devices.

21. The non-transitory computer-readable storage medium of claim 17, wherein the user data includes first user data, the one or more programs further comprising instructions for:
mirroring second user data on the two distinct memory devices, before generating the integrity data based on the first user data and storing the integrity data of the first user data on the integrity memory device.
